(19) United States
(12) Patent Application Publication
(10) Pub. No.: US 2026/0236938 A1
(43) Pub. Date: Aug. 13, 2026

(54) MANAGING CARBON CREDITS FOR INDIVIDUALS

(71) Applicant: Patcong Clark LLC, Las Vegas, NV (US)

(72) Inventors: Michael Allen Benedict, Washington, DC (US); Andrew James Lesofski, Washington, DC (US)

(21) Appl. No.: 19/180,090

(22) Filed: Apr. 15, 2025

Related U.S. Application Data
(60) Provisional application No. 63/634,546, filed on Apr. 16, 2024.

(51) Int. Cl. G06Q 30/018; G06Q 30/08; G06Q 40/04

(52) U.S. Cl. CPC G06Q 30/018; G06Q 30/08; G06Q 40/049; G06Q 40/055

(57) ABSTRACT

The systems disclosed herein generate and verify the creation of carbon credits for individuals and enable trading these carbon credits in a marketplace. In addition, the disclosed systems provide a way for a person to dedicate any carbon credits generated as a result of their passing or elevation (i.e., death) to the marketplace. Furthermore, the proceeds resulting from the sale of their carbon credits can be directed to accredited and verified environmental causes of their choice.

### CROSS-REFERENCE TO RELATED APPLICATIONS

This application claims priority to U.S. Prov. App. No. 63/634,546 filed Apr. 16, 2024 and entitled “MANAGING CARBON CREDITS FOR INDIVIDUALS,” which is expressly incorporated by reference herein in its entirety for all purposes.

### BACKGROUND

### Field

The present disclosure generally relates to systems and methods for generating and managing carbon credits for individuals.

### Description of Related Art

Companies around the world have been asked to reduce their carbon emissions (CO₂ emissions) to combat global warming and other environmental issues. As a consequence, companies have set climate targets aimed at carbon emission reduction. Various companies have been unable to achieve their goals but have been able to contribute to an overall reduction in carbon emissions through the use of carbon credits.

### SUMMARY

According to a number of implementations, the present disclosure relates to an elevation system that includes an intake module configured to receive client information and to generate a non-fungible token (NFT) with an embedded smart contract based on the received client information; and a verification module configured to scrape sources of public information on one or more networks to generate one or more elevation indicators associated with clients of the elevation system, to aggregate a weight of each elevation indicator to determine if the aggregated weight exceeds a verification threshold, responsive to exceeding the verification threshold, to create a candidate elevation event associated with the client that requires manual verification, and responsive to receiving indication of manual verification that the client has elevated, to generate carbon credits for the elevated client and to initiate an auction of the NFT created by the intake module.

In some implementations, the carbon credits are based at least in part on the client information. In some implementations, the carbon credits are based at least in part on an age of the elevated client at elevation. In some implementations, the generated carbon credits are further provided to a credit marketplace.

In some implementations, the client information includes an image. In some implementations, the image is used to generate the NFT. In some implementations, the NFT comprises the image.

In some implementations, the embedded smart contract includes directives dictating allocation of proceeds from the auction of the NFT. In some implementations, the embedded smart contract includes directives dictating allocation of proceeds from selling of the carbon credits. In some implementations, the embedded smart contract is configured to trigger the auction of the NFT responsive to receiving indication of manual verification that the client has elevated.

According to a number of implementations, the present disclosure relates to an elevation system that includes a network interface; a data store configured to store executable instructions; and a processor configured to control operation of the network interface and the data store. The processor is further configured to execute the stored executable instructions to cause the processor to: receive client information associated with a client from a device over the network interface; generate a non-fungible token (NFT) with an embedded smart contract based on the received client information; scrape sources of public information on one or more networks using the network interface; generate one or more elevation indicators associated with clients of the elevation system based on the public information; aggregate a weight of each elevation indicator to determine whether the aggregated weight exceeds a verification threshold; responsive to exceeding the verification threshold, create a candidate elevation event associated with the client that requires manual verification; and responsive to receiving an indication of manual verification that the client has elevated, generate carbon credits for the elevated client and initiate an auction of the NFT.

In some implementations, the carbon credits are based at least in part on the client information. In some implementations, the carbon credits are based at least in part on an age of the elevated client at elevation. In some implementations, the generated carbon credits are further provided to a credit marketplace.

In some implementations, the client information includes an image. In some implementations, the image is used to generate the NFT. In some implementations, the NFT comprises the image.

In some implementations, the embedded smart contract includes directives dictating allocation of proceeds from the auction of the NFT. In some implementations, the embedded smart contract includes directives dictating allocation of proceeds from selling of the carbon credits. In some implementations, the embedded smart contract is configured to trigger the auction of the NFT responsive to receiving indication of manual verification that the client has elevated.

According to a number of implementations, the present disclosure relates to a method for managing carbon credits for individuals.. The method includes receiving client information associated with a client from a device; generating a non-fungible token (NFT) with an embedded smart contract based on the received client information; scraping sources of public information on one or more networks; generating one or more elevation indicators associated with clients based on the public information; aggregating a weight of each elevation indicator to determine whether the aggregated weight exceeds a verification threshold; responsive to exceeding the verification threshold, creating a candidate elevation event associated with the client that requires manual verification; and responsive to receiving an indication of manual verification that the client has elevated, generating carbon credits for the elevated client and initiate an auction of the NFT.

In some implementations, the carbon credits are based at least in part on the client information. In some implementations, the carbon credits are based at least in part on an age of the elevated client at elevation. In some implementations, the generated carbon credits are further provided to a credit marketplace.

In some implementations, the client information includes an image. In some implementations, the image is used to generate the NFT. In some implementations, the NFT comprises the image.

In some implementations, the embedded smart contract includes directives dictating allocation of proceeds from the auction of the NFT. In some implementations, the embedded smart contract includes directives dictating allocation of proceeds from selling of the carbon credits. In some implementations, the embedded smart contract is configured to trigger the auction of the NFT responsive to receiving indication of manual verification that the client has elevated.

According to a number of implementations, the present disclosure relates to an elevation system that includes an intake module configured to receive client information associated with a client from a device, to generate a non-fungible token (NFT) based on the received client information, to generate a smart contract that is embedded in the NFT, and to store the NFT on a blockchain; and a verification module configured to trigger an auction of the NFT to responsive to receiving confirmation of elevation of the client.

In some implementations, the verification module is further configured to: scrape sources of public information on one or more networks to generate one or more elevation indicators associated with clients of the elevation system; aggregate a weight of each elevation indicator to determine if the aggregated weight exceeds a verification threshold; and responsive to exceeding the verification threshold, create a candidate elevation event associated with the client that requires confirmation.

In some implementations, the verification module is further configured to generate carbon credits for the elevated client responsive to receiving confirmation of elevation of the client. In some implementations, the smart contract includes directives that dictate disbursement of proceeds from the auction of the NFT.

In some implementations, the smart contract is configured to point to related transactions on the blockchain. In some implementations, the related transactions include a legal agreement executed by the client. In some implementations, the legal agreement is stored on the blockchain separately from the smart contract.

In some implementations, the auction of the NFT occurs in a separate system from the elevation system. In some implementations, the auction of the NFT occurs within the elevation system. In some implementations, the blockchain comprises a distributed ledger system.

According to a number of implementations, the present disclosure relates to an elevation system that includes a network interface; a data store configured to store executable instructions; and a processor configured to control operation of the network interface and the data store. The processor is further configured to execute the stored executable instructions to cause the processor to: receive client information associated with a client from a device; generate a non-fungible token (NFT) based on the received client information; generate a smart contract that is embedded in the NFT; store the NFT on a blockchain; and responsive to receiving confirmation of elevation, trigger an auction of the NFT.

In some implementations, the processor is further configured to: scrape sources of public information on one or more networks to generate one or more elevation indicators associated with clients of the elevation system; aggregate a weight of each elevation indicator to determine if the aggregated weight exceeds a verification threshold; and responsive to exceeding the verification threshold, create a candidate elevation event associated with the client that requires confirmation. In some implementations, the processor is further configured to generate carbon credits for the elevated client responsive to receiving confirmation of elevation of the client.

In some implementations, the smart contract includes directives that dictate disbursement of proceeds from the auction of the NFT. In some implementations, the smart contract is configured to point to related transactions on the blockchain. In some implementations, the related transactions include a legal agreement executed by the client. In some implementations, the legal agreement is stored on the blockchain separately from the smart contract.

In some implementations, the auction of the NFT occurs in a separate system from the elevation system. In some implementations, the auction of the NFT occurs within the elevation system. In some implementations, the blockchain comprises a distributed ledger system.

According to a number of implementations, the present disclosure relates to a method for triggering an auction of a non-fungible token (NFT) upon elevation of a client. The method includes receiving client information associated with a client from a device; generating a non-fungible token (NFT) based on the received client information; generating a smart contract that is embedded in the NFT; storing the NFT on a blockchain; and responsive to receiving confirmation of elevation, triggering an auction of the NFT.

In some implementations, the method further includes scraping sources of public information on one or more networks to generate one or more elevation indicators associated with clients; aggregating a weight of each elevation indicator to determine if the aggregated weight exceeds a verification threshold; and responsive to exceeding the verification threshold, creating a candidate elevation event associated with the client that requires confirmation. In some implementations, the method further includes generating carbon credits for the elevated client responsive to receiving confirmation of elevation of the client.

In some implementations, the smart contract includes directives that dictate disbursement of proceeds from the auction of the NFT.

In some implementations, the smart contract is configured to point to related transactions on the blockchain. In some implementations, the related transactions include a legal agreement executed by the client. In some implementations, the legal agreement is stored on the blockchain separately from the smart contract.

In some implementations, the auction of the NFT occurs in a separate auction system. In some implementations, the auction of the NFT occurs within an auction system integrated with an elevation system. In some implementations, the blockchain comprises a distributed ledger system.

According to a number of implementations, the present disclosure relates to an elevation system that includes an intake module configured to receive client information associated with a client from a device; and a verification module configured to scrape public information associated with the client; identify one or more elevation indicators associated with the client based on the scraped public information; aggregate a weight of each of the one or more elevation indicators; determine the aggregated weight of the one or more elevation indicators; responsive to the aggregated weight exceeding an elevation threshold, request confirmation of elevation of the associated client; and responsive to receiving confirmation of elevation, generate a quantity of carbon credits based at least in part on the received client information.

In some implementations, the intake module is further configured to receive client information associated with a client from a device; generate a non-fungible token (NFT) based on the received client information; generate a smart contract that is embedded in the NFT; and store the NFT on a blockchain. In some implementations, the verification module is further configured to trigger an auction of the NFT responsive to receiving confirmation of elevation.

In some implementations, the quantity of carbon credits is based at least in part on demographics and age of the client at elevation. In some implementations, the quantity of carbon credits is based at least in part on a residence location of the client. In some implementations, the one or more elevation indicators includes identifying information associated with the client in a social security death index. In some implementations, the one or more elevation indicators includes identifying information associated with the client in an obituary of a newspaper site. In some implementations, the one or more elevation indicators includes identifying information associated with the client in social media post. In some implementations, the weight of a particular elevation indicator is greater than the elevation threshold. In some implementations, confirmation of elevation is provided through a user device by a user that reviewed the one or more elevation indicators.

According to a number of implementations, the present disclosure relates to an elevation system that includes a network interface; a data store configured to store executable instructions; and a processor configured to control operation of the network interface and the data store. The processor is further configured to execute the stored executable instructions to cause the processor to: receive client information associated with a client from a device; scrape public information associated with the client; identify one or more elevation indicators associated with the client based on the scraped public information; aggregate a weight of each of the one or more elevation indicators; determine the aggregated weight of the one or more elevation indicators; responsive to the aggregated weight exceeding an elevation threshold, request confirmation of elevation of the associated client; and responsive to receiving confirmation of elevation, generate a quantity of carbon credits based at least in part on the received client information.

In some implementations, the processor is further configured to: receive client information associated with a client from a device; generate a non-fungible token (NFT) based on the received client information; generate a smart contract that is embedded in the NFT; and store the NFT on a blockchain. In some implementations, the processor is further configured to trigger an auction of the NFT responsive to receiving confirmation of elevation.

In some implementations, the quantity of carbon credits is based at least in part on demographics and age of the client at elevation. In some implementations, the quantity of carbon credits is based at least in part on a residence location of the client. In some implementations, the one or more elevation indicators includes identifying information associated with the client in a social security death index. In some implementations, the one or more elevation indicators includes identifying information associated with the client in an obituary of a newspaper site. In some implementations, the one or more elevation indicators includes identifying information associated with the client in social media post. In some implementations, the weight of a particular elevation indicator is greater than the elevation threshold. In some implementations, confirmation of elevation is provided through a user device by a user that reviewed the one or more elevation indicators.

According to a number of implementations, the present disclosure relates to a method for triggering a sale of carbon credits upon elevation of a client. The method includes receiving client information associated with a client from a device; scraping public information associated with the client; identifying one or more elevation indicators associated with the client based on the scraped public information; aggregating a weight of each of the one or more elevation indicators; determining the aggregated weight of the one or more elevation indicators; responsive to the aggregated weight exceeding an elevation threshold, requesting confirmation of elevation of the associated client; and responsive to receiving confirmation of elevation, generating a quantity of carbon credits based at least in part on the received client information.

In some implementations, the method further includes receiving client information associated with a client from a device; generating a non-fungible token (NFT) based on the received client information; generating a smart contract that is embedded in the NFT; and storing the NFT on a blockchain. In some implementations, the method further includes triggering an auction of the NFT responsive to receiving confirmation of elevation.

In some implementations, the quantity of carbon credits is based at least in part on demographics and age of the client at elevation. In some implementations, the quantity of carbon credits is based at least in part on a residence location of the client. In some implementations, the one or more elevation indicators includes identifying information associated with the client in a social security death index. In some implementations, the one or more elevation indicators includes identifying information associated with the client in an obituary of a newspaper site. In some implementations, the one or more elevation indicators includes identifying information associated with the client in social media post. In some implementations, the weight of a particular elevation indicator is greater than the elevation threshold. In some implementations, confirmation of elevation is provided through a user device by a user that reviewed the one or more elevation indicators.

According to a number of implementations, the present disclosure relates to a proceeds distribution system that includes a directive module configured to receive directives of a client related to proceeds from an auction of a non-fungible token (NFT) associated with the client and a sale of a quantity of carbon credits generated upon elevation of the client; and a distribution module configured to receive proceeds from an auction of the NFT, to receive proceeds from a sale of the quantity of carbon credits, and to distribute the proceeds to one or more causes or one or more entities identified in the received directives.

In some implementations, the directives are received after creation of the NFT associated with the client. In some implementations, the directives include instructions on a portion of the proceeds to allocate to a particular cause. In some implementations, the directives include instructions on a portion of the proceeds to allocate to a particular entity. In some implementations, the directives include instructions that allow a third party to allocate a portion of the proceeds to a cause or to an entity as the third party determines. In some implementations, the received directives are provided through a smart contract stored in a blockchain. In some implementations, the distribution module is further configured to generate a report of the distribution of the proceeds. In some implementations, the distribution module is further configured to interface with an auction system to automatically receive the proceeds from the auction of the NFT. In some implementations, the distribution module is further configured to interface with a carbon credit marketplace to automatically receive the proceeds from the sale of the quantity of carbon credits. In some implementations, the received directives are stored with the NFT on a blockchain.

According to a number of implementations, the present disclosure relates to a proceeds distribution system that includes a network interface; a data store configured to store executable instructions; and a processor configured to control operation of the network interface and the data store. The processor is further configured to execute the stored executable instructions to cause the processor to: generate a non-fungible token (NFT) based on client information associated with a client; generate a quantity of carbon credits responsive to confirmation of elevation of the client; receive proceeds from an auction of the NFT; receive proceeds from a sale of the quantity of carbon credits; receive directives of the client related to the proceeds from the auction of the NFT and the sale of the quantity of carbon credits; and distribute the proceeds to one or more causes or one or more entities identified in the received directives.

In some implementations, the directives are received after creation of the NFT associated with the client. In some implementations, the directives include instructions on a portion of the proceeds to allocate to a particular cause. In some implementations, the directives include instructions on a portion of the proceeds to allocate to a particular entity. In some implementations, the directives include instructions that allow a third party to allocate a portion of the proceeds to a cause or to an entity as the third party determines. In some implementations, the received directives are provided through a smart contract stored in a blockchain. In some implementations, the processor is further configured to generate a report of the distribution of the proceeds. In some implementations, the processor is further configured to interface with an auction system to automatically receive the proceeds from the auction of the NFT. In some implementations, the processor is further configured to interface with a carbon credit marketplace to automatically receive the proceeds from the sale of the quantity of carbon credits. In some implementations, the received directives are stored with the NFT on a blockchain.

According to a number of implementations, the present disclosure relates to a method for distributing proceeds from an auction of a non-fungible token associated with a client and a sale of carbon credits associated with the client. The method includes generating a non-fungible token (NFT) based on client information associated with a client; generating a quantity of carbon credits responsive to confirmation of elevation of the client; receiving proceeds from an auction of the NFT; receiving proceeds from a sale of the quantity of carbon credits; receiving directives of the client related to the proceeds from the auction of the NFT and the sale of the quantity of carbon credits; and distributing the proceeds to one or more causes or one or more entities identified in the received directives.

In some implementations, the directives are received after creation of the NFT associated with the client. In some implementations, the directives include instructions on a portion of the proceeds to allocate to a particular cause. In some implementations, the directives include instructions on a portion of the proceeds to allocate to a particular entity. In some implementations, the directives include instructions that allow a third party to allocate a portion of the proceeds to a cause or to an entity as the third party determines. In some implementations, the received directives are provided through a smart contract stored in a blockchain. In some implementations, the method further includes generating a report of the distribution of the proceeds. In some implementations, the method further includes automatically receiving the proceeds from the auction of the NFT from an auction system. In some implementations, the method further includes automatically receiving the proceeds from the sale of the quantity of carbon credits from a carbon credit marketplace. In some implementations, the received directives are stored with the NFT on a blockchain.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates an example of an elevation management system.

FIG. 2 illustrates an example proceeds distribution system that is configured to automatically manage and distribute proceeds from the auction of an NFT and proceeds from the sale of a quantity of carbon credits.

FIG. 3 illustrates a flow chart of an example method for auctioning an NFT generated by a client responsive to confirming that the client has elevated.

FIG. 4 illustrates a flow chart of an example method for selling carbon credits generated upon confirming that the client has elevated.

FIG. 5 illustrates a flow chart of an example method for distributing proceeds from the sale of NFTs and carbon credits.

FIG. 6 illustrates a block diagram of an example elevation system configured to create carbon credits based on client information, to provide the created carbon credits to a marketplace for sale upon confirmation of client elevation, to create NFTs based on client information, and to provide the created NFT to a service for sale upon confirmation of client elevation.

FIG. 7 illustrates a block diagram of an example proceeds distribution system configured to allocate proceeds from the sale of NFTs and carbon credits according to client directives.

### DETAILED DESCRIPTION OF SOME EMBODIMENTS

The headings provided herein, if any, are for convenience only and do not necessarily affect the scope or meaning of the claimed subject matter.

### Overview

The idea of a carbon credit is to allow one entity that cannot reduce carbon emissions to pay another entity to reduce theirs. Carbon credits are based on the idea that a marketplace that enables the trading or purchasing of carbon credits ultimately results in a reduction of overall carbon emissions. Carbon credits (and the associated marketplace) do this, in part, because they incentivize companies to reduce carbon emissions by providing a monetary reward if they are able to do so.

There are three basic sources of carbon credits: reduced emissions (e.g., energy efficiency measures), removed emissions (e.g., carbon capture, planting forests, etc.), and avoided emissions (e.g., refraining from cutting down rainforests). A carbon credit marketplace allows one entity to buy the carbon credits generated by another entity to offset their own carbon emissions. Unfortunately, there is a lack in standardization in the way to trade carbon credits and for verifying a qualifying offsetting activity that generated the carbon credits in the first place.

One significant issue with the carbon credit marketplace is that individuals are left out. Currently, there is no way for individuals to be rewarded for their efforts in reducing their personal carbon footprint. Various government and non-government entities have issued reports on the size of individuals'carbon footprint. Around these reports, several carbon footprint calculators have emerged that enable any person to estimate their carbon footprint, which is similar to the carbon emission of a company. These calculators show how an individual's status, age, geography, and choices impact their carbon footprint. Flowing from this idea is that each individual is responsible for a certain amount of carbon emissions. Consequently, it follows, any reduction, removal, or avoidance of emissions by an individual should naturally result in the generation of carbon credits, similar to any other entity. These carbon credits should then be available for trade in the carbon credit marketplace with the proceeds for the sale of such carbon credits going to the individual that created them.

Accordingly, the systems disclosed herein generate and verify the creation of carbon credits for individuals and enable trading these carbon credits in a marketplace. In addition, the disclosed systems provide a way for a person to dedicate any carbon credits generated as a result of their passing or elevation (i.e., death) to the marketplace. Furthermore, the proceeds resulting from the sale of their carbon credits can be directed to accredited and verified environmental causes of their choice. Also disclosed are systems that can automatically generate actuarial metascores for individuals, the actuarial metascore related to the likelihood that a person will generate less carbon emissions than would a typical person in the same situation. The actuarial metascore can be used in different marketplaces such as futures markets and securities markets backed by tranches of people with relatively high metascores.

The duration of a person's life is one of the largest contributions to their carbon footprint, so if that person were to unfortunately pass before reaching the average lifespan, that early passing generates carbon credits in the form of avoided emissions. The individual can dedicate any carbon credits generated from their early passing to the marketplace and the resulting proceeds can be directed to a cause or entity of the individual's choosing, resulting in a positive outcome from an unfortunate event. Similarly, any activities the person takes throughout their life to reduce their carbon footprint can generate carbon credits in the form of reduced emissions.

In addition, the disclosed systems create and memorialize a legal agreement using a non-fungible token (NFT) on a blockchain, the legal agreement designed to dedicate generated carbon credits from an individual to the marketplace. As used herein, an NFT can be any non-fungible digitized information which differentiates it from a fungible token and can include, for example, a digital certificate, a picture, digitized customer information, digitized client data, and the like or any combination of these. The legal agreement can also identify a cause or entity, or multiple causes or entities, that receive proceeds from the sale of the generated carbon credits. At a person's elevation, the NFT can be auctioned off and proceeds from that sale can also be distributed as defined in the legal agreement. In this way, the purchaser of the NFT can have a memorial of the elevated individual's legacy and contribute to that legacy through the purchase of the NFT. In addition, one or more additional legal agreements can dedicate other assets that can be used to fund preferred causes and entities based on directives in the legal agreements.

Furthermore, the disclosed systems automatically verify the passing (i.e., elevation) of an individual legally contracted within the system. The system is configured to scrape multiple databases to generate a notification of a possible elevation of an individual within the system. This notification can be verified by one or more persons and this verification can be used to trigger the automatic execution of the legal agreement. The result of the execution of the legal agreement is that (1) carbon credits generated by the elevated individual are made available in the marketplace and (2) the NFT is auctioned. The proceeds from one or more of these events are directed to entities and/or causes identified in directives memorialized in one or more previously executed legal agreements.

The following provides an example of a way that an individual may generate carbon credits. According to estimates, a typical person in the United States of America has a total carbon footprint of about 16-22 tons of CO₂/year (considering travel, home, food, goods, and services). In addition, the typical current price of a carbon credit is between about $15-$30 per ton of CO₂ in the US (or about $100 in Europe). Given that the average life expectancy of a person in the US is about 75 years, an average person can be expected to be responsible for about 1500 tons of CO₂. If a person were to die before reaching the average life expectancy, that unfortunate event results in a calculable amount of avoided emissions. If, for example, the person passes at the age of 65, the total amount of avoided emissions is about 200 tons of CO₂ which can be valued anywhere from about $3000 to about $20,000, depending on the carbon credit marketplace and the value of carbon credits at that time. This money can be used to further various worthy causes the elevated person championed during their lifetime. Although carbon credits are discussed throughout this disclosure, it is to be understood that other natural asset credits could be used in place of carbon credits. Natural asset credits can include, for example and without limitation, water credits, renewable energy credits, regenerative credits, nitrogen credits, biodiversity credits, methane credits, and the like.

In addition, although throughout this disclosure the sale of carbon credits is described as being initiated by the elevation of the client, it is to be understood that other uses for an individual's associated carbon credits are contemplated within. For example, the disclosed technologies can provide a portion or an entirety of any carbon credits associated with an individual as tradeable assets prior to elevation of the client. In some instances, the disclosed technologies can be configured to make available a portion of potential carbon credits in a futures market to enable customers or traders to lock in a current price of carbon credits for future acquisition once the carbon credits are validated and/or verified.

Other methods can be used to determine carbon credits associated with an individual. For example, at a person's birth, the total estimated amount of carbon emissions that the person is expected to use can be assigned as an expected carbon utilization value. Throughout the person's life, the person can take steps to reduce the amount of carbon utilized so that carbon credits can be generated throughout their lifetime, not just at their elevation. This also allows the person to prepare trusts, wills, and similar legal documents that assign generated credits to any entity or person of their choosing. Similarly, probate proceedings can also be used to assign generated credits to living persons or other entities.

Thus, disclosed herein are technologies and platforms that offer individuals a unique way to leave a lasting environmental and social legacy upon their elevation (i.e., death). By leveraging the concept of carbon credits, NFTs, and asset donations, the disclosed technologies provide a way to bridge the gap between personal legacy and global impact.

### Example Elevation System

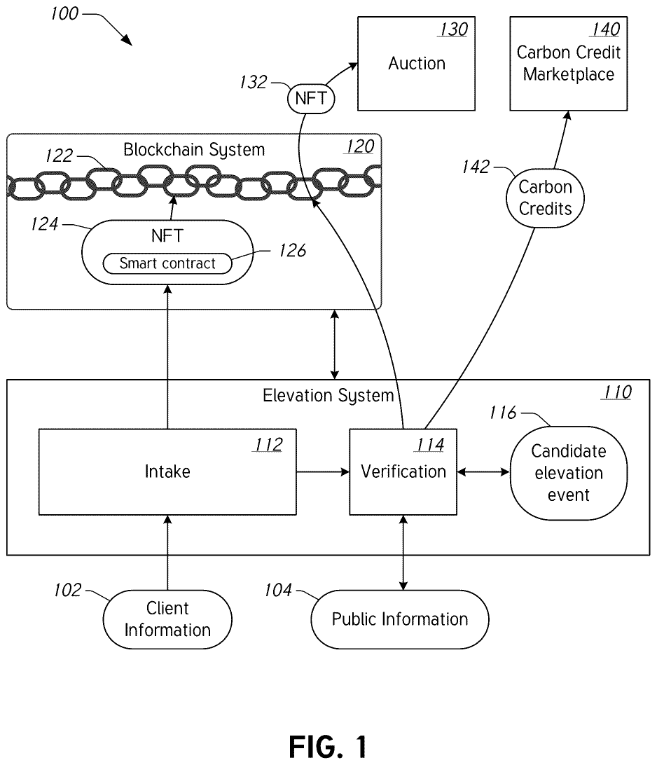

FIG. 1 illustrates an example of an elevation management system 100. The elevation management system 100 is configured to manage information and credits associated with clients of the elevation management system 100, the information and credits related to the elevation of such clients. The elevation management system 100 is also configured to initiate actions upon confirmed elevation of the clients of the elevation management system 100. These actions include, for example, auctions of digital assets, posting carbon credits to a marketplace, and/or managing distribution of proceeds from the auctions or sales of credits.

Because one or more actions within the elevation management system 100 are triggered by confirmed elevation of a client, the elevation management system 100 is configured to monitor databases, social media feeds, websites, and the like to identify elevation indicators. Based on one or more elevation indicators the elevation management system 100 is configured to generate candidate elevation events associated with a client. As used herein, the term “elevation” or “elevated” when used in relation to an individual refers to the passing or death of that individual. Thus, elevation indicators are data points that serve as evidence that an individual has elevated, and candidate elevation events are generated when the one or more elevation indicators are sufficient to exceed a threshold of proof that an individual has passed.

The elevation management system 100 includes an elevation system 110 that is configured to receive client information 102 and to inspect public information 104. The elevation system 110 includes an intake module 112 and a verification module 114. The intake module 112 receives client information 102. Client information 102 includes any information about the client provided by the client or derived from information provided by the client. This can include, for example and without limitation, personal information (e.g., name, height, weight, medical history, etc.), demographic information (e.g., birth date, residence location, gender, race, etc.), lifestyle information (e.g., diet, frequency of exercise, employment, familial status, etc.), and the like.

The intake module 112 is also configured to generate a digital asset, such as a non-fungible token or NFT 124, as part of the intake process. The NFT 124 is generated using a picture and/or other digital information provided by the client as part of client information 102. In addition, as part of the intake process, the intake module 112 is configured to provide legal documents for execution by the client. The intake module 112 is configured to generate a smart contract 126 as part of the intake process. For example, the smart contract 126 can be used to trigger the auction of the NFT 124 using an auction system 130 upon confirmation of elevation of the associated client. The smart contract 126 can also be used to trigger generation or assignment of carbon credits that can be traded or sold on a carbon credit marketplace 140. In some embodiments, the smart contract 126 can be embedded as part of the NFT 124. The NFT 124 can be stored in a blockchain system 120 on a blockchain structure 122. The blockchain system 120 can be any suitable system that provides a blockchain structure 122 or similar distributed ledger system. In some embodiments, the intake module 112 can create an additional NFT certificate to signify the end of the sign-up process. This NFT certificate can be provided for use by the client to indicate association with the elevation system 110. In some implementations, the intake module 112 is configured to generate an estimate of potential carbon credits based on self-reported data associated with client information 102. Similarly, the intake module 112 can be configured to generate an estimate of potential carbon credits using regional life expectancy and individual habits as determined from client information 102. Thus, an individual's carbon credits can be considered to be created at birth and can be accrued over their lifetime. Accrual of carbon credits during life can be achieved by typical means such as avoided emissions, eliminated emissions, and reduced emissions.

The verification module 114 interfaces with public information 104. Public information 104 includes publicly accessible data via a network, such as the Internet. Public information 104 includes, for example and without limitation, social media feeds, government services (e.g., the social security death index), news feeds, websites, and the like.

The verification module 114 is configured to monitor public information 104 to identify elevation indicators. Elevation indicators can include, for example and without limitation, obituaries on news sites, official notices in government databases, statements that an individual has passed on social media or other websites, or the like. The verification module 114 is configured to establish a proof threshold such that, upon exceeding the proof threshold, the verification module 114 is configured to generate a candidate elevation event 116 indicating a likelihood that a particular client has elevated. In some embodiments, each elevation indicator can be assigned a weight, score, or other value associated with the trustworthiness of the indicator or source of the indicator. In such embodiments, responsive to the combined value of the elevation indicators surpassing the proof threshold, the verification module 114 generates the candidate elevation event 116. In certain cases, an individual elevation indicator is sufficiently trustworthy or reliable to surpass the proof threshold.

Upon confirmation of a candidate elevation event, the elevation system 110 automatically determines the number of carbon credits 142 (or other natural asset credits) generated based on one or more characteristics of the elevated client, e.g., determined based at least in part on client information 102, making those carbon credits 142 available in the carbon credit marketplace 140. In addition, the elevation system 110 automatically provides the NFT 124 associated with the elevated client to the auction system 130. The proceeds from the auction of the NFT 124 as well as the proceeds from the sale of the carbon credits 142 can be used to aid specific causes or entities indicated by the client prior to their elevation. In some embodiments, the elevation system 110 can request confirmation of elevation of an associated client. The request can go to a user or operator of the elevation system 110. For example, confirmation of elevation can be provided through a user device by a user that reviewed the one or more elevation indicators. In some implementations, if elevation occurs due to suicide, the carbon credits can be negated so as to dissuade self harm as a means to generate carbon credits and/or to avoid carbon emissions. In some implementations, medically assisted suicide or euthanasia can be an acceptable process for elevation.

Thus, the elevation management system 100 allows clients to assign carbon credits 142 generated by the client upon their elevation. Calculation of the carbon credits 142 is based on client information 102. The client information 102 can be based at least in part on self-reported information about clients' daily life habits and regional data. Client information 102 includes demographic details such as name, age, and gender. Client information 102 also includes region-specific information such as the geographical location where the client lives and the kind of environment the client lives in. Client information 102 can also include details related to the client's personal behavior including, for example, their daily habits, activities, and other behaviors that might affect the environment. Client information 102 can also include details about the client's perceived environmental impact which involves the client assessing their perceived daily impact on the environment, with possible scale ratings or multiple-choice questions. Client information 102 can be collected by the intake module 112. In addition, the intake module 112 can provide questionnaires, surveys, or the like to collect client information 102. In some implementations, the client information 102 can be updated periodically or intermittently during the client's lifetime. This can lead to the generation of carbon credits during their lifetime, which may be assigned, sold, or transferred using any number of legal procedures including using the carbon credit marketplace 140.

Once client information 102 is provided, the elevation system 110 (e.g., via the intake module 112) can automatically verify at least some of the self-reported data (e.g., age, geographical location) using official documents (e.g., government documents). Based on this verified and self-reported information, the elevation system 110 calculates an estimate of the client's carbon footprint over their lifetime. This allows the elevation system 110 (e.g., via the verification module 114) to calculate the avoided emissions, and the resulting carbon credits produced, should the client elevate before reaching their life expectancy. The elevation system 110 can use international standards to estimate or determine the number of carbon credits produced upon a client's elevation, e.g., using the United Nations Carbon Offset Platform.

Upon verification of elevation, the elevation system 110 automatically makes these carbon credits 142 available for sale in the carbon credit marketplace 140, with proceeds channeled to environmental, social, or climate-focused projects as directed by the client. The verification module 114 is configured to continuously scrape public information 104 including public records and other sources, such as social media, to determine when a client has elevated. Events or information that may indicate that a client has passed are designated “elevation indicators.” Once the aggregate validity of the elevation indicators has surpassed a threshold, the candidate elevation event 116 is generated so that the client is indicated as a candidate for verification of elevation. Verification of elevation can be provided by the verification module 114 and/or an external source. Once verification has been established (e.g., by a person reviewing all available data), the elevation system 110 receives that verification and automatically triggers the elevation protocol: determining any carbon credits 142 generated due to the client's elevation, sending those carbon credits 142 to the carbon credit marketplace 140, and providing the NFT 132 to the auction system 130.

In some instances, an estimate of the amount of carbon credits 142 can be generated prior to the client's elevation for use in a futures market (e.g., as part of the carbon credit marketplace 140) for customers to purchase at a current price. In such instances, transfer of the carbon credits 142 can occur at the time of confirmed elevation of the client (or when the client's elevation is verified and/or validated). In some instances, actuarial metascores can be automatically determined for a plurality of clients and these actuarial metascores can be used to generate tranches of future carbon credits. These tranches can be managed, traded, and sold using the carbon credit marketplace 140 or other futures markets. In some implementations, a secondary market can be generated that extracts carbon credits associated with individuals from the designated tranches and these extracted carbon credits can be sold at a discount. These may operate similar to mortgage-backed securities based on the actuarial metascores, for example.

The verification module 114 can be configured to scrape the Internet to find information indicating elevation of a client. This can include scraping news sites for obituaries and checking the information against the Social Security Death Index. This can also include scraping social media sites for information that may indicate a client has elevated. For example, the verification module 114 is configured to scrape public obituaries, that is, the verification module 114 scans publicly posted obituaries from various regional sources. The verification module 114 cross-references the obituary details with the client's demographic and regional data provided as client information 102 to the intake module 112 during sign-up for accurate verification. The verification module 114 monitors this information for each client. Once elevation is confirmed, the verification module 114 triggers the creation of the carbon credits 142 and the auction of the NFT 132, as described herein.

One element of the elevation system 110 is that as part of the sign-up process, clients create the NFT 124 that embeds the smart contract 126. The client does this by submitting a picture they wish to use as the NFT 124 that will be auctioned off when they elevate. In some embodiments, the intake module 112 facilitates creation of the NFT 124. In some embodiments, the intake module 112 receives an image from the client as part of client information 102 and the intake module 112 triggers automatic creation of the NFT 124. The NFT 124 embeds the smart contract 126 that causes the transfer of carbon credits 142 generated by the client at their elevation (e.g., avoided carbon emissions due to early elevation) as well as authorization to auction the NFT 132 (e.g., where the NFT 132 corresponds to the NFT 124 created by the intake module 112 during the intake process). The NFT 132 no longer includes the smart contract 126 embedded in the NFT 124. The NFT 124 as well as other legal documents can be stored in a persistent database, which can utilize blockchain technology, such as the blockchain system 120 that utilizes the blockchain structure 122. A blockchain can be advantageous because it provides security, immutability of the legal document, and verifiable proof of the transaction. In some embodiments, the smart contract 126 points to related transactions on the blockchain structure 122 that include the legal agreement. In some implementations, the legal agreement is stored on the blockchain structure 122 separately from the smart contract 126. This allows the company, the client, and any third party the ability to verify the legal agreements as well as the foundation for the creation of the carbon credits 142.

Thus, the intake module 112 generates the NFT 124 and stores it on the blockchain system 120. Client information 102 is also passed to the verification module 114 that scrapes public information 104 to generate candidate elevation events 116. As described herein, once a sufficient threshold has been passed, the verification module 114 generates the candidate elevation event 116 associated with a particular client. Once verified manually, the verification module 114 triggers creation of the carbon credits 142 to be sold in the carbon credit marketplace 140 and triggers an auction of the NFT 132 created by the intake module 112.

In some implementations, the smart contract 126 contains an agreement and/or executable code to initiate transfer of unused carbon credits to the entity controlling the elevation system 110 upon confirmed elevation. The smart contract 126 can also include details of any property or other asset the client wishes to deed to the entity controlling the elevation system 110. The smart contract 126 can also include an agreement regarding the sale of the NFT 132 and the utilization of proceeds. The smart contract 126 can also include an agreement regarding the sale of the carbon credits 142 and the utilization of proceeds.

As described herein, the verification module identifies elevation indicators. An elevation indicator can be a mention in a social media feed that indicates a client has elevated. An elevation indicator can be an obituary in a regional newspaper for a client. An elevation indicator can be finding the client's name in the Social Security Death Index. Each of these elevation indicators, and other such indicators, can be assigned a weight. If the aggregate weight exceeds a verification threshold, the candidate elevation event 116 is triggered. This causes an alert or notification to be generated that prompts a person to manually verify the information to confirm that the client has indeed elevated. In some embodiments, the weight of an individual elevation indicator can be sufficiently large so that the single event exceeds the verification threshold. For example, an elevation indicator where the client's name is found in an obituary or on the Social Security Death Index can have a weight sufficient to trigger creation of the candidate elevation event 116.

Thus, the elevation system 110 includes the intake module 112 that is configured to receive client information 102 and to generate the NFT 124 with the embedded smart contract 126 based on the received client information 102. The elevation system 110 also includes the verification module 114 that is configured to scrape sources of public information 104 on one or more networks to generate elevation indicators for clients of the elevation system 110. The verification module 114 is configured to aggregate a weight of each elevation indicator to determine if the aggregated weight exceeds a verification threshold. Upon exceeding the verification threshold, the verification module 114 is configured to create a candidate elevation event 116 that requires manual verification. Upon receiving indication of manual verification, the verification module 114 is configured to generate carbon credits 142 for the elevated client and to initiate an auction of the NFT 132 created by the intake module 112.

In some embodiments, the elevation system 110 is configured to store the NFT 124 and smart contract 126 on the blockchain structure 122 along with other legal documents. The legal documents can be linked to the NFT 124 and the smart contract 126 within the blockchain system 120. In some embodiments, client attributes derived or generated based on client information 102 can be stored within the blockchain system 120. The client attributes can be linked to the NFT 124 and the smart contract 126 as well asl the legal documents within the blockchain system 120. In some embodiments, directives regarding distribution of the proceeds of the auction of the NFT 132 and the sale of the carbon credits 142 can be stored within the blockchain system 120. These directives can also be linked to the NFT 124, smart contract 126, and associated legal documents. In some embodiments, the directives can be used to create the smart contract 126 and/or can be embedded as part of the smart contract 126. In this way, the relevant information associated with the client can be stored and linked within the blockchain system 120. Furthermore, in some embodiments, the proof of elevation associated with the client can be stored within the blockchain system 120. This provides auditable proof of the elevation indicators resulting in the confirmed elevation event.

### Example Proceeds Distribution System

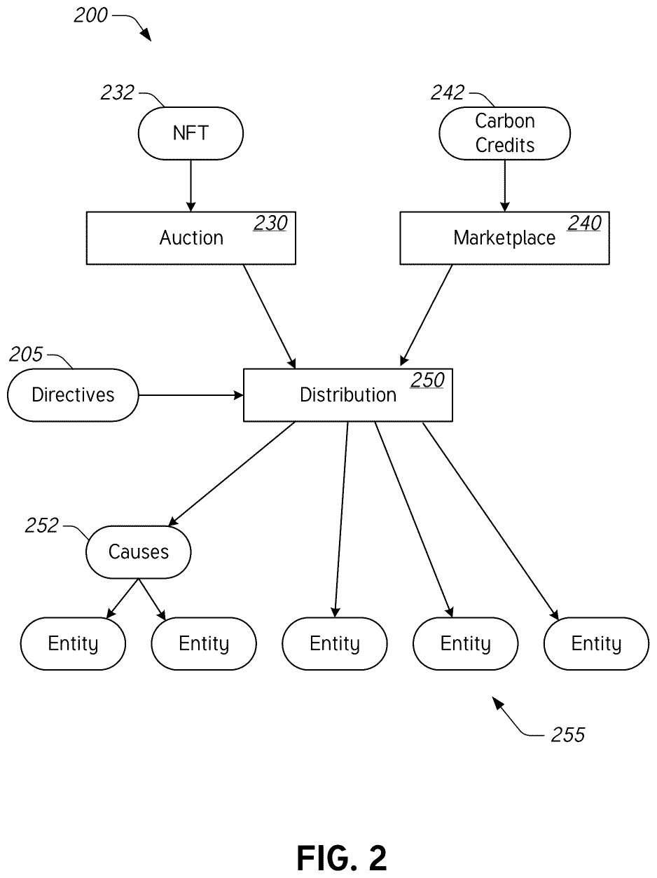

FIG. 2 illustrates an example proceeds distribution system 200 that is configured to automatically manage and distribute proceeds from the auction of an NFT 232 and proceeds from the sale of a quantity of carbon credits 242. As described herein, the NFT 232 can be created based on client information, such as an image provided by the client. Upon confirmed elevation of the associated client, the NFT 232 can be auctioned off by an auction service 230. Similarly, as described herein, carbon credits 242 can be generated upon confirmed elevation of a client and/or during the life of the client. The carbon credits 242 associated with the client can be based on client information as well as other factors. The generated carbon credits 242 can be sent to a marketplace 240 for sale of the carbon credits 242.

The proceeds from the auction service 230 and the marketplace 240 can be provided to a distribution subsystem 250. The distribution subsystem 250 receives directives 205 associated with the elevated client. The directives 205 can be provided by the client during the intake process, as described herein, or at any other time during the life of the client. The directives 205 can be stored with the NFT 232 on a blockchain structure and can be embedded in legal documents stored on the blockchain and/or within a smart contract associated with the NFT 232 and/or embedded within the NFT 232. The directives 205 can be a set of instructions for allocating any proceeds resulting from the auction of the NFT 232 and/or the sale of the carbon credits 242.

The directives 205 can include instructions to allocate a portion of the proceeds to one or more entities 255 and/or to one or more causes 252. As used herein, the one or more causes 252 can be referred to as a grouping of similar entities that can be decided by a third party (e.g., a person other than the client). This allows for the client to choose a cause to be benefited by the allocated proceeds without needing to vet individual entities. For example, the directives 205 can dictate the allocation or disbursement of proceeds from the auction of the NFT 232 and/or the sale of the carbon credits 242.

In some embodiments, the distribution subsystem 250 is configured to automatically generate a reporting of the allocation of the distributed proceeds. This can be used to provide an accounting to relatives of the elevated client or other interested parties.

Accordingly, the distribution subsystem 250 allows clients to assign proceeds from the sale of their carbon credits, such as upon their elevation. Using self-reported information about clients' daily life habits and regional data, the elevation system 110 of FIG. 1 estimates the carbon emissions a client might utilize in their lifetime compared to a typical person with similar demographics and/or client information. The carbon credits 242 represent the amount of carbon emissions the client did not utilize relative to the estimated amount of emissions. Upon permission from the client and/or elevation verification, these carbon credits 242 can be made available for sale, with profits channeled to environmental, social, or climate-focused projects as directed by the client via the directives 205. In some instances, the carbon credits 242 (or a portion thereof) can be made available in a futures market, as described herein. The futures market may aggregate carbon credits or potential carbon credits from a plurality of clients. Grouping of clients may occur based on actuarial metascores, as described herein. In some implementations, the directives 205 include instructions that allow a third party to allocate a portion of the proceeds to a cause or to an entity as the third party determines. In such implementations, the third party can select projects that align with the legacy or intended legacy of the elevated client.

Similarly, as part of the sign-up process, clients create the NFT 232 that embeds a smart contract. This smart contract details the transference of unused carbon credits upon the client's elevation. Upon elevation, the client's unique NFT 232 is auctioned, further contributing to their chosen legacy mission. Proceeds from NFT and carbon credit sales are used to fund projects (e.g., entities 255 and/or causes 252) chosen by the client. The projects can be selected, curated, and vetted by the operator of the elevation system 110 of FIG. 1. These projects can be aligned with various metrics such as environmental, social, and governance metrics and can include, for example and without limitation, reforestation efforts, clean water initiatives, and community-based climate resilience projects.

As described herein, the elevation system 110 of FIG. 1 provides the verification module 114 to confirm a client's elevation. In some implementations, the verification module 114 uses a variety of tools such as newspaper obituaries and the Social Security Death Index. In this way, the elevation system 110 and the proceeds distribution system 200 provide an advantageous approach to legacy planning. These disclosed technologies offer individuals the chance to make a significant posthumous contribution to the environment and to society. Advantageously, the disclosed technologies help to ensure that each client's legacy translates to real-world positive impacts.

### Example Methods

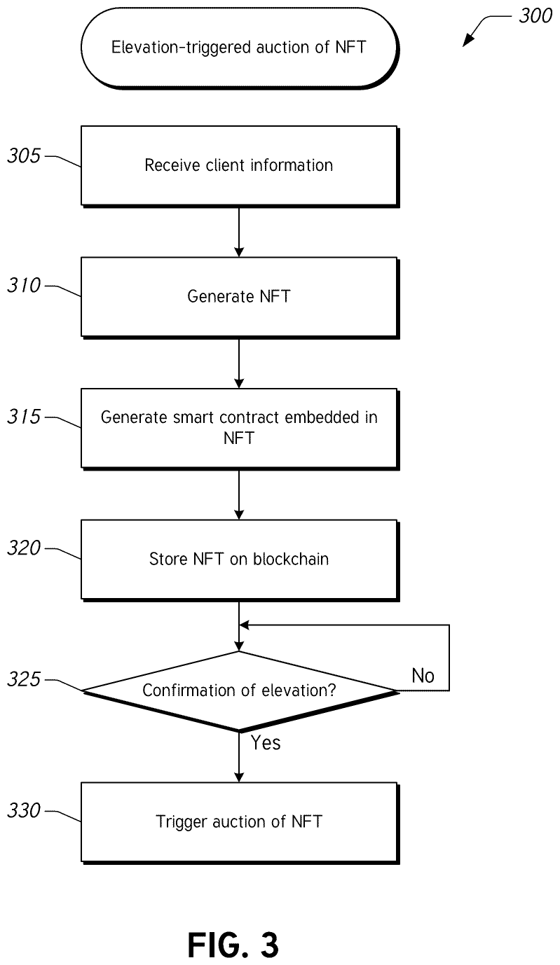

FIG. 3 illustrates a flow chart of an example method 300 for auctioning an NFT generated by a client responsive to confirming that the client has elevated. As described herein with reference to FIGS. 1 and 2, the client aids in creating an NFT that is representative of the client and/or their legacy and, upon confirmation of their passing, the client's NFT is posted to an auction service or other such service to be sold so that the proceeds can be distributed according to the client's directives. The method 300 can be performed by any of the systems, subsystems, or modules described herein with reference to FIGS. 1 and 2 or by a combination of systems, subsystems, and/or modules. However, for ease of description, the method 300 will be described as being performed by an elevation system. This is not to be understood to limit the scope of the disclosure. Rather, any step or portion of the method 300 can be performed by any component or combination of components of the systems described herein.

At block 305, the elevation system receives client information indicating characteristics of the client that can be used to generate an NFT. At block 310, the elevation system generates the NFT based on the received client information. At block 315, the elevation system generates a smart contract that is embedded in the NFT. The smart contract can include executable code triggered by the elevation of the client, as described herein. At block 320, the elevation system stores the NFT with the embedded smart contract on a blockchain. At block 325, the elevation system receives confirmation of the elevation of the client. Responsive to receiving such confirmation, the elevation system triggers the auction of the associated NFT at block 330.

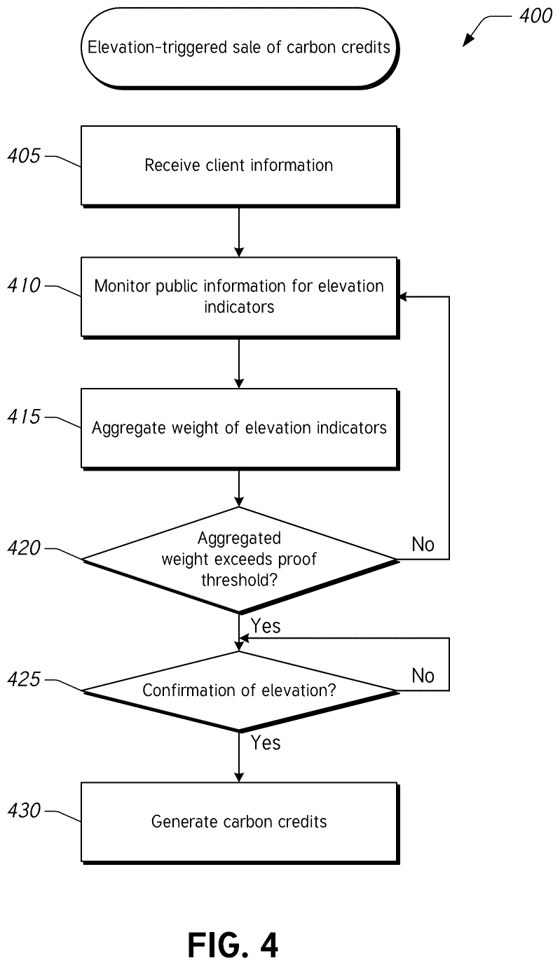

FIG. 4 illustrates a flow chart of an example method 400 for selling carbon credits generated upon confirming that the client has elevated. As described herein with reference to FIGS. 1 and 2, the confirmed elevation of a client triggers the creation of carbon credits based on client information which are then provided to a marketplace where the carbon credits are sold. The method 400 can be performed by any of the systems, subsystems, or modules described herein with reference to FIGS. 1 and 2 or by a combination of systems, subsystems, and/or modules. However, for ease of description, the method 400 will be described as being performed by an elevation system. This is not to be understood to limit the scope of the disclosure. Rather, any step or portion of the method 400 can be performed by any component or combination of components of the systems described herein.

At block 405, the elevation system receives client information indicating characteristics of the client that can be used to determine carbon credits, including an estimate of carbon credits at any point in time as well as a determination of carbon credits at the time the client elevates. At block 410, the elevation system monitors public information to determine one or more elevation indicators. At block 415, the elevation system aggregates the weight of individual elevation indicators for each client. At block 420, the elevation system determines whether the aggregated weight exceeds a proof threshold. If not, the elevation system returns to block 410 to monitor public records. If the proof threshold is exceeded, a candidate elevation event is sent for confirmation. Upon receiving confirmation of elevation at block 425, the elevation system proceeds to block 430 to generate the carbon credits according to the client information received at block 405.

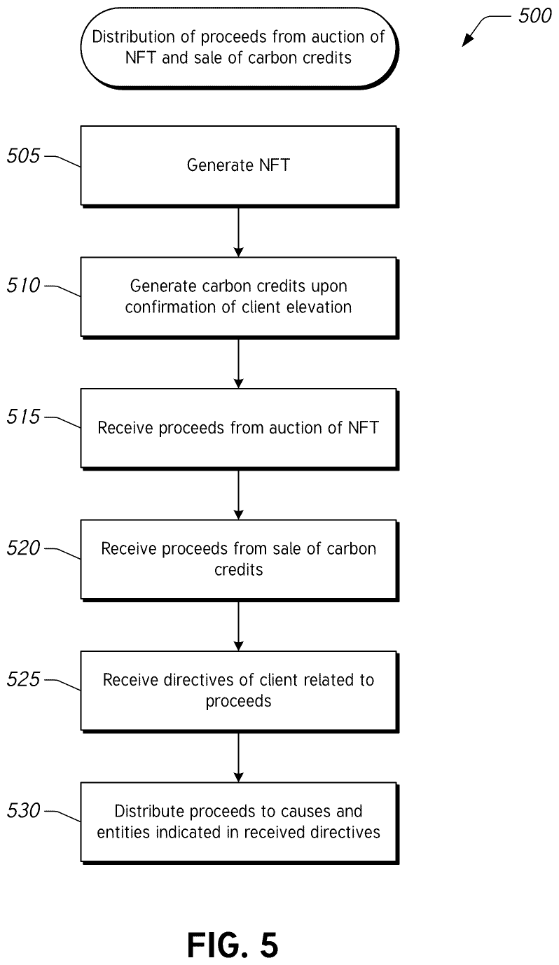

FIG. 5 illustrates a flow chart of an example method 500 for distributing proceeds from the sale of NFTs and carbon credits. As described herein with reference to FIGS. 1 and 2, upon confirmation of elevation, an NFT associated with the elevated client is generated and auctioned and carbon credits associated with the elevated client are generated and sold. The proceeds from these sales are distributed according to the method 500. The method 500 can be performed by any of the systems, subsystems, or modules described herein with reference to FIGS. 1 and 2 or by a combination of systems, subsystems, and/or modules. However, for ease of description, the method 500 will be described as being performed by a distribution system. This is not to be understood to limit the scope of the disclosure. Rather, any step or portion of the method 500 can be performed by any component or combination of components of the systems described herein.

At block 505, the distribution system generates an NFT based on received client information, such as an image provided by the client. At block 510, the distribution system generates carbon credits upon verification of client elevation, the number of carbon credits based on client information associated with the client. At block 515, the distribution system receives proceeds from the sale or auction of the NFT. At block 520, the distribution system receives proceeds from the sale of the generated carbon credits. At block 525, the distribution system receives client directives indicating the client's instructions on distribution of the proceeds from the sale of the NFT and carbon credits, the allocation being provided to one or more causes, one or more projects, and/or one or more entities. At block 530, the distribution system allocates the proceeds according to the client directives.

### Example Systems

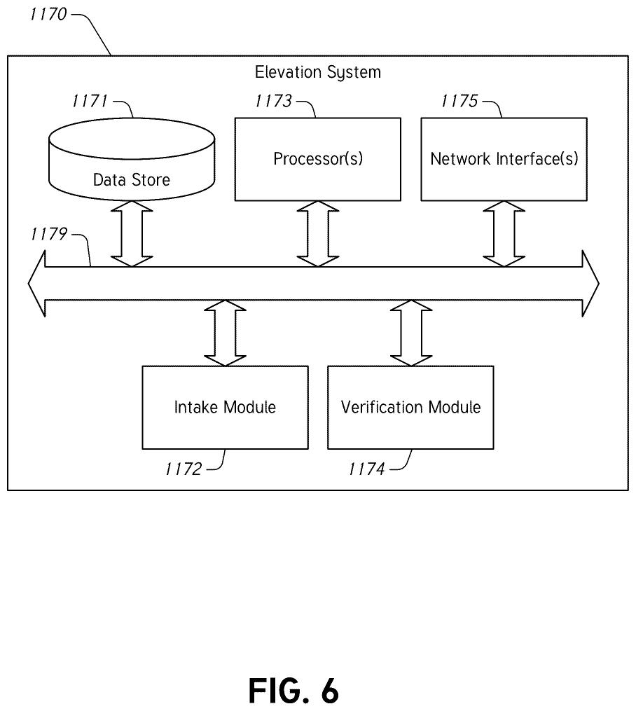

FIG. 6 illustrates a block diagram of an example elevation system 1170 configured to generate carbon credits based on client information, to provide the created carbon credits to a marketplace for sale upon confirmation of client elevation, to create NFTs based on client information, and to provide the created NFT to a service for sale upon confirmation of client elevation. The elevation system 1170 is similar to the elevation system 110 described herein with reference to FIG. 1 and can be implemented in the elevation management system 100 there described. The elevation system 1170 can employ any method described herein for managing and selling NFTs and carbon credits, such as the example methods 300, 400 described herein with reference to FIGS. 3 and 4, respectively.

The elevation system 1170 can include hardware, software, and/or firmware components for managing elevation-related data, functions, and assets. The elevation system 1170 includes a data store 1171, one or more processors 1173, one or more network interfaces 1175, an intake module 1172, and a verification module 1174. Components of elevation system 1170 can communicate with one another, with external systems, and with other components of a network using communication bus 1179. The elevation system 1170 can be implemented using one or more computing devices. For example, the elevation system 1170 can be implemented using a single computing device, multiple computing devices, a distributed computing environment, or it can be located in a virtual device residing in a public or private computing cloud. In a distributed computing environment, one or more computing devices can be configured to provide the modules 1172, 1174 to provide the described functionality.

The elevation system 1170 includes the intake module 1172 to receive client information and to generate NFTs, smart contracts, legal documents, and client directives, as described herein. The elevation system 1170 includes the verification module 1174 to monitor public information to generate elevation indicators and to generate candidate elevation events based on the generated elevation indicators, as described herein. In addition, the modules 1174 is configured to generate carbon credits upon confirmation of client elevation, as described herein.

The elevation system 1170 includes one or more processors 1173 that are configured to control operation of the modules 1172, 1174 and the data store 1171. The one or more processors 1173 implement and utilize the software modules, hardware components, and/or firmware elements to provide the functionality of the modules 1172, 1174. The one or more processors 1173 can include any suitable computer processors, application-specific integrated circuits (ASICs), field programmable gate array (FPGAs), or other suitable microprocessors. The one or more processors 1173 can include other computing components configured to interface with the various modules and data stores of the elevation system 1170.

The elevation system 1170 includes the data store 1171 configured to store configuration data, client information, public information, client directives, databases, algorithms, executable instructions (e.g., instructions for the one or more processors 1173), and the like. The data store 1171 can be any suitable data storage device or combination of devices that include, for example and without limitation, random access memory, read-only memory, solid-state disks, hard drives, flash drives, bubble memory, and the like.

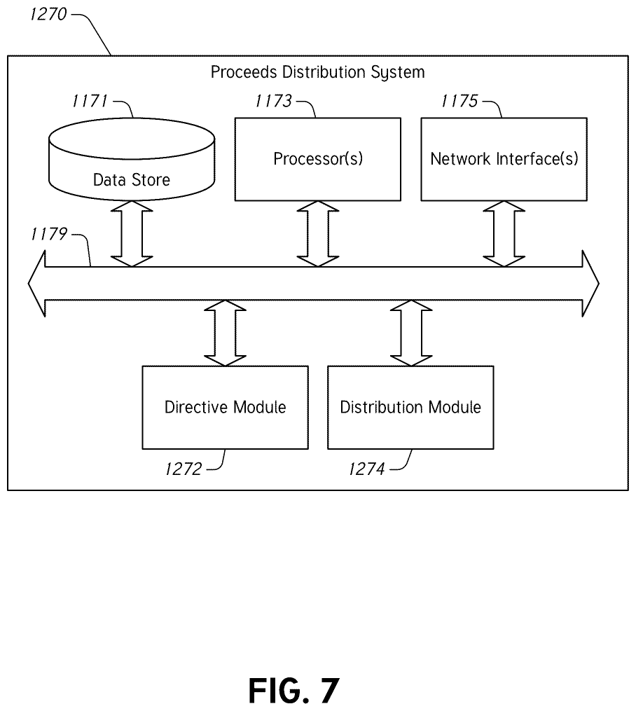

FIG. 7 illustrates a block diagram of an example proceeds distribution system 1270 configured to allocate proceeds from the sale of NFTs and carbon credits according to client directives. The proceeds distribution system 1270 is configured to receive client directives and data associated with the proceeds from auctions and sales of NFTs and carbon credits. The proceeds distribution system 1270 is similar to the proceeds distribution system 200 described herein with reference to FIG. 2. The proceeds distribution system 1270 can employ any method described herein for allocating proceeds according to client directives, such as the example method 500 described herein with reference to FIG. 5.

The proceeds distribution system 1270 can include hardware, software, and/or firmware components for managing the allocation of proceeds according to client directives. Similar to the elevation system 1170, the proceeds distribution system 1270 includes a data store 1171, one or more processors 1173, and one or more network interfaces 1175. The proceeds distribution system 1270 also includes a directive module 1272 and a distribution module 1274. Similar to the elevation system 1170, components of proceeds distribution system 1270 can communicate with one another, with external systems, and with other components of a network using communication bus 1179. The proceeds distribution system 1270 can be implemented using one or more computing devices. For example, the proceeds distribution system 1270 can be implemented using a single computing device, multiple computing devices, a distributed computing environment, or it can be located in a virtual device residing in a public or private computing cloud. In a distributed computing environment, one or more computing devices can be configured to provide the modules 1272, 1274 to provide the described functionality.

The proceeds distribution system 1270 includes the directive module 1272 to receive client directives and to translate those directives to executable commands for the distribution module 1274, as described herein. The proceeds distribution system 1270 includes the distribution module 1274 to distribute received funds or proceeds according to the directives provided by the directive module 1272, as described herein. The distribution module 1274 can also be configured to generate reports associated with the allocation of funds or proceeds according to the client directives, as described herein.

Similar to the elevation system 1170, the proceeds distribution system 1270 includes one or more processors 1173 that are configured to control operation of the modules 1272, 1274 and the data store 1171. The one or more processors 1173 implement and utilize the software modules, hardware components, and/or firmware elements to provide the functionality of the modules 1272, 1274. Similar to the elevation system 1170, the one or more processors 1173 can include any suitable computer processors, application-specific integrated circuits (ASICs), field programmable gate array (FPGAs), or other suitable microprocessors. The one or more processors 1173 can include other computing components configured to interface with the various modules and data stores of the proceeds distribution system 1270.

Similar to the elevation system 1170, the proceeds distribution system 1270 includes the data store 1171 configured to store configuration data, client directives, records of proceeds, databases, algorithms, executable instructions (e.g., instructions for the one or more processors 1173), and the like. The data store 1171 can be any suitable data storage device or combination of devices that include, for example and without limitation, random access memory, read-only memory, solid-state disks, hard drives, flash drives, bubble memory, and the like.

### Additional Embodiments and Terminology

As used herein, the term actuarial metascores can refer to an automated calculation of a ranking or score that is correlated to demographic and other client information as it pertains to carbon emissions. Actuarial metascores, for example, can rate a client with a high score if it is highly likely that they will generate a relatively large amount of carbon credits based at least in part on client information, such as client demographics.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The disclosure is not intended to be limited to the implementations shown herein. Various modifications to the implementations described in this disclosure may be readily apparent to those skilled in the art, and the generic principles defined herein may be applied to other implementations without departing from the scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the scope of the disclosure. The accompanying claims and their equivalents are intended to cover such forms or modifications as would fall within the scope of the disclosure.

What is claimed is:

1. An elevation system comprising:
an intake module configured to receive client information and to generate a non-fungible token (NFT) with an embedded smart contract based on the received client information; and
a verification module configured to scrape sources of public information on one or more networks to generate one or more elevation indicators associated with clients of the elevation system, to aggregate a weight of each elevation indicator to determine if the aggregated weight exceeds a verification threshold, responsive to exceeding the verification threshold, to create a candidate elevation event associated with the client that requires manual verification, and responsive to receiving indication of manual verification that the client has elevated, to generate carbon credits for the elevated client and to initiate an auction of the NFT created by the intake module.

2. The elevation system of claim 1, wherein the carbon credits are based at least in part on the client information.

3. The elevation system of claim 1, wherein the carbon credits are based at least in part on an age of the elevated client at elevation.

4. The elevation system of claim 1, wherein the generated carbon credits are further provided to a credit marketplace.

5. The elevation system of claim 1, wherein the client information includes an image.

6. The elevation system of claim 5, wherein the image is used to generate the NFT.

7. The elevation system of claim 6, wherein the NFT comprises the image.

8. The elevation system of claim 1, wherein the embedded smart contract includes directives dictating allocation of proceeds from the auction of the NFT.

9. The elevation system of claim 1, wherein the embedded smart contract includes directives dictating allocation of proceeds from selling of the carbon credits.

10. The elevation system of claim 1, wherein the embedded smart contract is configured to trigger the auction of the NFT responsive to receiving indication of manual verification that the client has elevated.

11. An elevation system comprising:
a network interface;
a data store configured to store executable instructions; and
a processor configured to control operation of the network interface and the data store, the processor further configured to execute the stored executable instructions to cause the processor to:
receive client information associated with a client from a device over the network interface;
generate a non-fungible token (NFT) with an embedded smart contract based on the received client information;
scrape sources of public information on one or more networks using the network interface;
generate one or more elevation indicators associated with clients of the elevation system based on the public information;
aggregate a weight of each elevation indicator to determine whether the aggregated weight exceeds a verification threshold;
responsive to exceeding the verification threshold, create a candidate elevation event associated with the client that requires manual verification; and
responsive to receiving an indication of manual verification that the client has elevated, generate carbon credits for the elevated client and initiate an auction of the NFT.

12. The elevation system of claim 11, wherein the carbon credits are based at least in part on the client information.

13. The elevation system of claim 11, wherein the carbon credits are based at least in part on an age of the elevated client at elevation.

14. The elevation system of claim 11, wherein the generated carbon credits are further provided to a credit marketplace.

15. The elevation system of claim 11, wherein the client information includes an image.

16. The elevation system of claim 15, wherein the image is used to generate the NFT.

17. The elevation system of claim 16, wherein the NFT comprises the image.

18. The elevation system of claim 11, wherein the embedded smart contract includes directives dictating allocation of proceeds from the auction of the NFT.

19. The elevation system of claim 11, wherein the embedded smart contract includes directives dictating allocation of proceeds from selling of the carbon credits.

20. The elevation system of claim 11, wherein the embedded smart contract is configured to trigger the auction of the NFT responsive to receiving indication of manual verification that the client has elevated.
